(19) United States
(12) Patent Application Publication
(10) Pub. No.: US 2025/0315686 A1
(43) Pub. Date: Oct. 9, 2025

(54) ADVERSARIAL EXAMPLE GENERATION SYSTEM

(71) Applicant: Capital One Services, LLC, McLean, VA (US)

(72) Inventors: Anthony Glynn, Fairfax, VA (US); Keith Gasser, Woodbridge, VA (US); Peter Tanski, Marlborough, MA (US); James Harris, McLean, VA (US); Michael James Caughey, Chesterfield, VA (US)

(21) Appl. No.: 18/629,019

(22) Filed: Apr. 8, 2024

(51) Int. Cl. G06N 3/094

(52) U.S. Cl. CPC G06N 3/094

(57) ABSTRACT

Aspects described herein may automatically generate adversarial examples configured to train a machine learning model. A computing device may receive a request to generate a plurality of adversarial examples for a first machine learning model. The plurality of adversarial examples may be configured to be input to the first machine learning model and cause misclassification by the first machine learning model. The plurality of adversarial examples may be generated using a second machine learning model modified from a ground truth example. The computing device may send, to the first machine learning model, the plurality of adversarial examples. The first machine learning model may be configured to be adjusted based on a comparison between a respective output classification for each of the plurality of adversarial examples; and data indicating a correct classification for each of the plurality of adversarial examples.

### FIELD OF USE

Aspects of the disclosure relate generally to data processing. More specifically, aspects of the disclosure may provide for systems and methods for generating adversarial examples.

### BACKGROUND

A machine learning model may be trained to perform a task. For example, an image recognition model may be trained to recognize an object (e.g., a face, a stop sign, etc.) in an image. However, the machine learning model may disproportionally rely on some data points associated with the input. This may lead to incorrect outputs when the machine learning model processes certain inputs. For example, incorrect outputs may occur if the data points that the machine learning model heavily relies on differ from those the machine learning model usually encounters. An effective way to improve the machine learning model is needed.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

A machine learning model may be trained to undertake various tasks. Some tasks may require the machine learning model to output results with a high accuracy rate. For example, an image recognition model may be trained to recognize traffic signs. The image recognition model may be used in a self-driving vehicle. Recognizing the traffic signs with a high accuracy rate may be crucial, because misclassifying a traffic sign may potentially lead to a traffic accident. The machine learning model may be trained using a plurality of labeled inputs as training data. For example, the training data for the image recognition model may comprise a plurality of images taken from the street, with the traffic sign being labeled. The training data may be input into the image recognition model. The image recognition model may learn to recognize the traffic signs based on a correlation between certain data points in the image and the labeled traffic sign(s) in the image. However, the image recognition model may disproportionally rely on one or more data points and may incorrectly classify objects in certain images if the heavily relied upon data points in these images are different from what the image recognition model ordinarily receives.

For example, the image recognition model may recognize a stop sign by heavily relying on a combination of a red round shape and the text of “stop.” As a result, an image of a red balloon with the text “stop” may be incorrectly classified as a stop sign by the image recognition model, for example, because the red balloon image may be similar to the corresponding data points in an image of an ordinary stop sign. In another example, the image recognition model may distinguish the number “3” from the number “8” by heavily relying on graphical patterns near the junction where the two half-circles meet in number “3” (or where the two full-circles meet in number “8”), rather than relying on whether the circles are complete or not. In a 35-mile speed limit sign, if a colored tape is placed at the junction area of the number “3,” the image recognition model may incorrectly recognize that 35-mile speed limit sign as an 85-mile speed limit sign, for example, because the graphical patterns of the junction area are more similar to those in an ordinary number “8” instead of those in an ordinary number “3.” The images of the red balloon or the taped 35-mile speed limit, which trick a machine learning model into producing incorrect output (often due to a variation of data points that the machine learning model heavily relies on) may be referred to as adversarial examples. The output from a machine learning model may be incorrect if the corresponding input is an adversarial example.

To overcome limitations in the prior art described above, and to overcome other limitations that will be apparent upon reading and understanding the present specification, aspects described herein are directed towards automatically generating adversarial examples. The adversarial examples may be used to train a machine learning model, so that the machine learning model may be unlikely to be tricked (e.g., to produce incorrect output) by similar adversarial examples. In at least some embodiments, a computing device may receive a request to generate a plurality of adversarial examples for a first machine learning model. The first machine learning model may be configured to output a classification for an input. The plurality of adversarial examples may be configured to be input to the first machine learning model and cause misclassification by the first machine learning model. The computing device may receive information associated with the first machine learning model, and generate, based on the request and using a second machine learning model, the plurality of adversarial examples. Each of the plurality of adversarial examples may be modified from a ground truth example. The computing device may send, to the first machine learning model, the plurality of adversarial examples. The first machine learning model may be configured to be adjusted based on a comparison between: a respective output classification for each of the plurality of adversarial examples; and data indicating a correct classification for each of the plurality of adversarial examples.

The computing device may further receive, from the first machine learning model, the respective output classification for each of the plurality of adversarial examples; and retrain, based on adversarial examples misclassified by the first machine learning model, the second machine learning model.

The first machine learning model may be further configured to output a respective confidence level associated with each output classification. The retraining the second machine learning model may be further based on a respective confidence level corresponding to each of the output classifications associated with the plurality of adversarial examples.

The information associated with the first machine learning model comprises at least one of: metadata associated with input fields of the first machine learning model; or one or more parameters of the first machine learning model.

The first machine learning model may be configured to: recognize an image; and classify the recognized image into one of a plurality of categories.

The computing device may generate the plurality of adversarial examples by: determining one or more data points that are assigned, by the first machine learning model, a weight exceeding a threshold; and modifying a portion, in each of a plurality of ground truth examples, that corresponds to the one or more data points.

The computing device may further receive, from the first machine learning model, a plurality of confidence levels, each associated with a respective classification for a corresponding second input of a plurality of second inputs; and may trigger, based on the plurality of confidence levels satisfying a threshold, the request to generate the plurality of adversarial examples.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example of a computing environment in accordance with one or more illustrative aspects discussed herein;

FIG. 3 depicts an example of deep neural network architecture for a machine learning model according to one or more illustrative aspects discussed herein;

FIG. 4 is a flow diagram of an example method for generating adversarial examples in accordance with one or more illustrative aspects discussed herein;

FIG. 5 is a flow diagram of an example method for generating adversarial examples in accordance with one or more illustrative aspects discussed herein;

FIG. 6A is an illustrative image for adversarial example generation in accordance with one or more illustrative aspects discussed herein.

FIG. 6B is an illustrative image for adversarial example generation in accordance with one or more illustrative aspects discussed herein.

### DETAILED DESCRIPTION

In the following description of the various embodiments, reference is made to the accompanying drawings, which form a part hereof, and which are shown by way of illustration of various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

A machine learning model described herein may be trained to generate adversarial examples. The adversarial examples may be configured to cause misclassification of another machine learning model (e.g., an image recognition model). The adversarial examples may be used to train the other machine learning model, so that the other machine learning model may be unlikely to be tricked (e.g., to produce incorrect output) by similar adversarial examples. The adversarial examples may be generated based on a modification to the ground truth examples and may be supplemented as a part of the training data. The adversarial examples may initially trick the other machine learning model and cause the other machine learning model to generate incorrect outputs. The other machine learning model may be improved based on a comparison of the incorrect output and data indicating a corresponding correct output, and/or may learn to produce correct outputs (e.g., correct classifications of objects in an image) based on the adversarial examples. Aspects discussed herein may improve the functioning of a computer system because a machine learning model (e.g., the image recognition model) may improve the accuracy of its output after being trained by the plurality of adversarial examples.

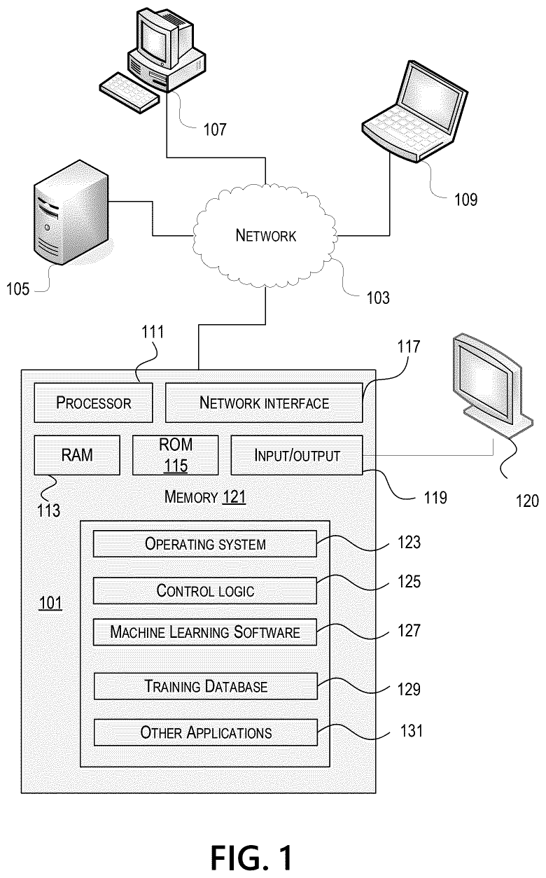

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, machine learning software 127, training database 129, and other applications 131 may be stored in the memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

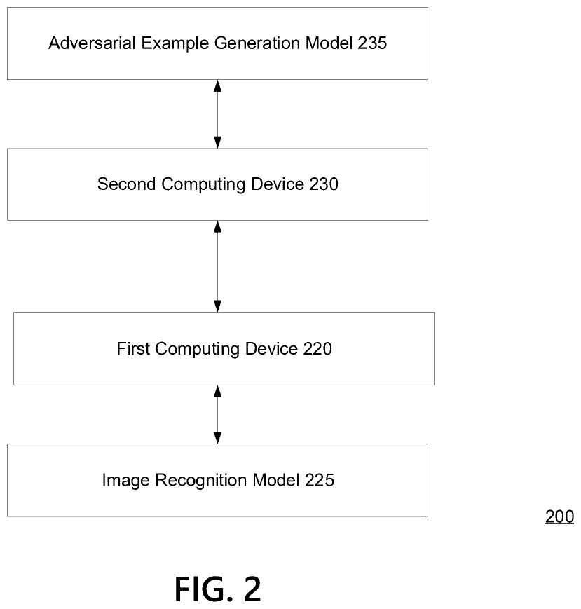

FIG. 2 depicts an illustrative computing environment for generating adversarial examples in accordance with one or more example embodiments. Referring to FIG. 2, computing environment 200 may include a first computing device 220 and a second computing device 230. Each of the first computing device 220 and the second computing device 230 may be a computing device 101 as described in FIG. 1. Each of the first computing device 220 and the second computing device 230 may communicate with other devices via network 103 as described in FIG. 1.

The first computing device 220 may be connected with a first machine learning model 225. The first machine learning model may be executed on the first computing device 220 (e.g., as shown in FIG. 2) or may be executed on another computing device that communicates with the first computing device 220. The first machine learning model may be trained to perform a task (e.g., recognizing an object in an image). The first machine learning model may be trained based on a plurality of training data. For example, an image recognition model may be trained to recognize an object in an image. The image recognition model may classify a portion of the image into an object category corresponding to the object that the portion depicts. For example, the image recognition model may classify a portion of a photo taken on the street into a particular traffic sign.

The training data for the first machine learning may be labeled. For example, the training data for the image recognition model may comprise a plurality of images taken by a camera from the street. In each image, a portion that corresponds to a traffic sign may be labeled. The image recognition model may learn to recognize the traffic sign in future input images based on a correlation between data points (e.g., graphical patterns, certain pixels in the image, etc.) in the labeled portion and the traffic sign. For example, the image recognition model may learn to correlate a red round circle with the text of “STOP” in the middle of the circle with a stop sign, and may classify an image of such a red round circle as a stop sign in the future.

The first machine learning model, after being trained by the training data, may disproportionally rely on one or more data points (e.g., relied on whether a red round circle with the text “STOP” in the middle of the circle to determine the present of a stop sign) to make future prediction. In such a situation, if the heavily relied upon data points, of an input, are different from what ordinarily is present in the training data, the first machine learning model may misclassify the input. Disproportionally relying on certain data points may cause the first machine learning model to make mistakes that ordinary human beings may be unlikely to make. For example, if a red balloon with the text “stop” is present on the street, the image recognition model may incorrectly recognize the balloon as a stop sign, even if an ordinary human being would be unlikely to not make a similar mistake. In another example, the image recognition model may distinguish an image of the number “3” from an image of number “8” by heavily relying on the graphical pattern near the junction where the two half-circles of number “3” meet (or where the two full circles of number “8” meet), rather than discerning whether the two circles are complete or not. If a colored tape is placed near the junction area, the image recognition model may incorrectly recognize the number “3” as the number “8,” and therefore recognize a 35-mile speed limit sign as an 85-mile speed limit sign, even if an ordinary human being may be unlikely to make similar mistakes.

It is appreciated that the discussion herein may use the image recognition model trained to recognize traffic signs as an example of the first machine learning, but the first machine learning model may be any type of machine learning model. For example, the first machine learning model may include, but not limited to, a natural language processing (NLP) model, a speech recognition model, a time series forecasting model, a video generation/processing model, a three-dimensional (3D) deep learning model, or any other models that are trained to perform other tasks.

An input entry that is configured to cause a machine learning model, which is trained using ordinary training data (e.g., ground truth data obtained from real life), to output incorrect results (e.g., normally because the input entry has unusual features associated with the data points the machine learning model heavily relies upon) that may be referred to as an adversarial example. To improve the output accuracy of the first machine learning model, systems that automatically generate adversarial examples may be needed.

As shown in FIG. 2, the second computing device 230 may be connected with a second machine learning model (e.g., an adversarial example generation model 235) configured to generate adversarial examples. As described below in further detail, the adversarial examples may be generated and sent to the first machine learning model, for example, to train the first machine learning model. The adversarial example generation model 235 may generate adversarial examples in a format that the first machine learning model may receive as input. For example, the first machine learning model may receive digital data of different formats (images, video, text, audio, etc.) that are obtained from sensors in the real world. The adversarial example generation model 235 may generate examples using the same format (e.g., generating a photograph if the first machine learning model 225 receives data from a camera). The adversarial example generation model 235 may be executed on the second computing device 230 (e.g., as shown in FIG. 2) or may be executed on another computing device that communicates with the second computing device 230. As described herein, the information associated with the first machine learning model may be sent to the adversarial example generation model 235 via the communication channel between the second computing device 230 and the first computing device 220, for example, to facilitate the generation of the adversarial examples.

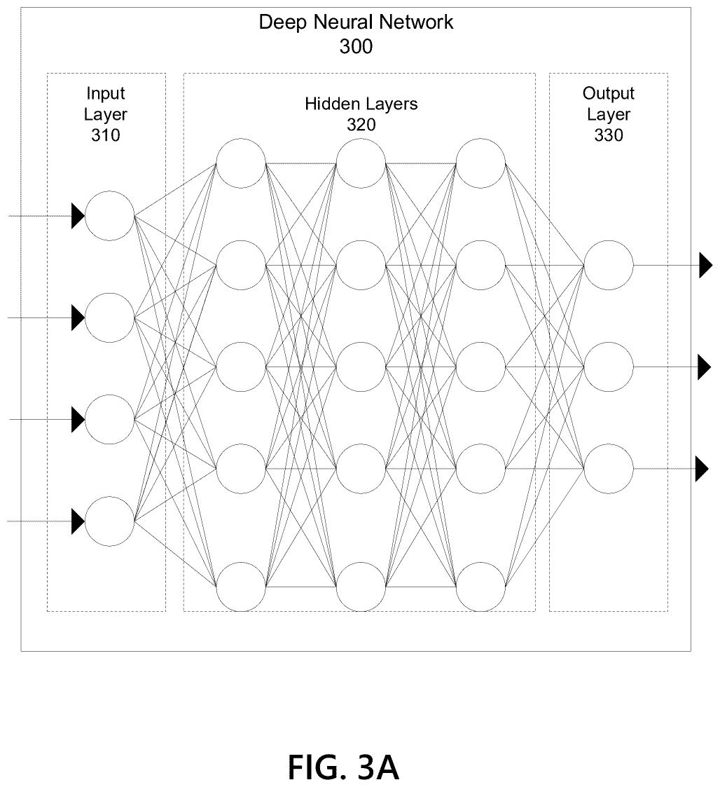

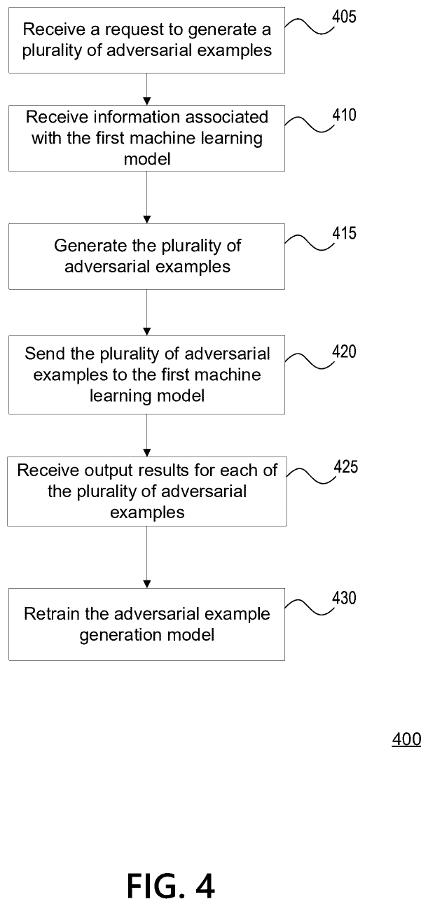

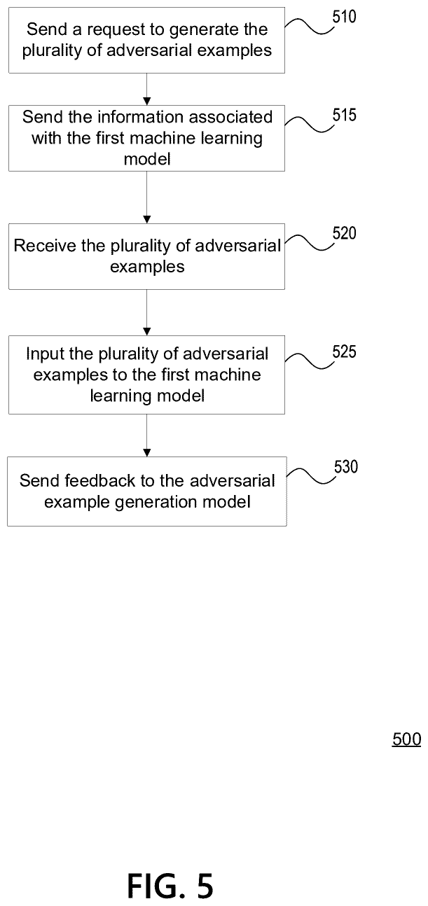

FIG. 3 illustrates an example of machine learning model 300. The machine learning model 300 may comprise one or more neural networks, including but not limited to: a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), a consistent adversarial network (CAN) (e.g., a cyclic generative adversarial network (C-GAN), a deep convolutional GAN (DC-GAN), GAN interpolation (GAN-INT), GAN-CLS, a cyclic-CAN (e.g., C-CAN), etc.), or any equivalent thereof. Additionally or alternatively, the machine learning model 300 may comprise one or more decision trees. In some instances, the one or more machine learning model 300 may comprise a Hidden Markov Model. Such a machine learning model architecture may be all or portions of the machine learning software 127 shown in FIG. 1. The machine learning model 300 may be all or portions of the machine learning models (e.g., the adversarial example generation model 235 or the first machine learning model 225) described in connection with FIG. 2, FIG. 4, and/or FIG. 5. The architecture depicted in FIG. 3 need not be performed on a single computing device, and may be performed by, e.g., a plurality of computers (e.g., one or more of the devices 101, 105, 107, 109). The machine learning model 300 may comprise one or more artificial neural networks. The artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 310, one or more hidden layers 320, and an output layer 330. A deep neural network, as used herein, may be an artificial network that has more than one hidden layer. Illustrated network architecture 300 is depicted with three hidden layers, and thus may be considered a deep neural network. The number of hidden layers employed in the deep neural network 300 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The machine learning model 300 may be initialized with a random or white noise set of initial model parameters. The model parameters may then be iteratively adjusted using, for example, stochastic gradient descent algorithms that seek to minimize errors in the model.

FIG. 4 is a flow diagram depicting method 400 for generating adversarial examples in accordance with one or more illustrative aspects discussed herein. The steps in method 400 may be performed by a system comprising, for example, the first computing device 220, the second computing device 230, the adversarial example generation model 235, and/or the first machine learning model 225 (e.g., the image recognition model) as may be shown in FIG. 2.

At step 405, a second computing device 230 may receive a request to generate a plurality of adversarial examples. The plurality of adversarial examples may be used to train a first machine learning model 225. The first machine learning model may be configured to output a result based on an input. Consistent with the example of the image recognition model trained to recognize traffic signs (e.g., as described in FIG. 2), the image recognition model may be trained to output an indication regarding whether a traffic sign is present in an input image. If a traffic sign is present in an input image, the image recognition model may also output an indication that indicates what type of traffic sign is present.

The plurality of adversarial examples may be configured to trick the first machine learning model (e.g., cause an incorrect output from the first machine learning model). As described above with respect to FIG. 2, the adversarial examples may be configured to cause misclassification by the image recognition model. The plurality of adversarial examples may comprise features (or data points) that are different from what an ordinary training image comprises.

At step 410, the second computing device 230 may receive information associated with the first machine learning model. For example, the information associated with the first machine learning model may comprise metadata associated with input fields and/or output fields of the first machine learning model. For example, the input fields of the image recognition model may comprise an input image taken from a camera (e.g., while a self-driving car is on the street). The output fields of the image recognition model may comprise: a first field indicating whether a traffic sign is present in the input image (e.g., values of this output field may comprise yes or no), a second field indicating what category of traffic sign the present traffic sign belongs to (e.g., values of this output field may comprise stop sign, speed limit sign, no parking sign, etc.), and/or a third field indicating what specific information is in the traffic sign (e.g., for a speed limit sign, the values of this output field may indicate a specific speed limit).

Additionally or alternatively, the information associated with the first machine learning model may also comprise one or more parameters depicting how the first machine learning model makes decisions. For example, if the first machine learning model comprises a neural network, the information may comprise weights and biases (e.g., as discussed in connection with FIG. 3) in the neural network. In another example, the information may comprise analysis results showing the decision-making of the first machine learning model (e.g., analysis associated with activation maps in deep learning models, local interpretable model-agnostic explanation (LIME), etc.). This may be helpful, for example, particularly for complicated machine learning models in which the weights and/or biases are either not obtainable or difficult to utilize directly. It is appreciated that the analyzing tools are merely examples, and data results from other analyzing tools are possible.

Additionally or alternatively, the information associated with the first machine learning model may also comprise a training goal for the adversarial examples. The training goal may describe a particular type of misclassification that the adversarial examples are configured to cause. For example, a training goal associated with an image recognition model may comprise generating adversarial examples to cause misclassifying a particular character (misclassifying “3” with “8” in a stop sign image) or misclassifying a feature (e.g., the gender or age) associated with a face recognized in an image.

At step 415, the second computing device 230 may generate, based on the request, the plurality of adversarial examples. The second computing device 230 may generate the plurality of adversarial examples using the adversarial example generation model 235. For example, the second computing device 230 may input, to the adversarial example generation model 235, the information associated with the first machine learning model (e.g., as described in step 410).

The adversarial example generation model 235 may generate each of the adversarial examples by modifying a ground truth example. A ground truth example may comprise an example obtained from real life. For example, the adversarial example generation model 235 may determine one or more data points the first machine learning model heavily relies upon. For example, the one or more data points may be the data points that are each assigned, by the first machine learning model, a relatively high weight. For example, the adversarial example generation model 235 may determine the data points being assigned a weight that exceeds a threshold. The one or more data points may be determined based on the information (e.g., weights, bias, analysis results as described in step 410) associated with the first machine learning model. For example, if the first machine learning model is relatively simple, the one or more data points may be selected directly based on the weights of the first machine learning model. If the first machine learning model is relatively complex, the one or more data points may be selected (e.g., estimated or predicted) based on analysis data (e.g., the activate map or LIME) discussed above.

The adversarial example generation model 235 may generate an adversarial example by modifying a portion, of the ground truth examples, that corresponds to the one or more data points. The one or more data points of the ground truth example may be modified in a way such that the corresponding data points in the adversarial example are different in the ground truth example and/or not ordinarily seen in other ground truth examples. The adversarial example generation model 235 may initially generate multiple variations (e.g., randomly or based on initial parameters) based on one ground truth example. Some variations may be able to trick the first machine learning model. Some variations may not be able to trick the first machine learning model. The variations that trick the first machine learning model may be selected (e.g., by engineers or by a computing device based on one or more rules). Additionally or alternatively, the variations may be input to the first machine learning model (either with or without the pre-selection) to test which one or more variations tricks the first machine learning model. The variations that trick the first machine learning model may be used as training data to improve the first machine learning model, as described below in greater detail.

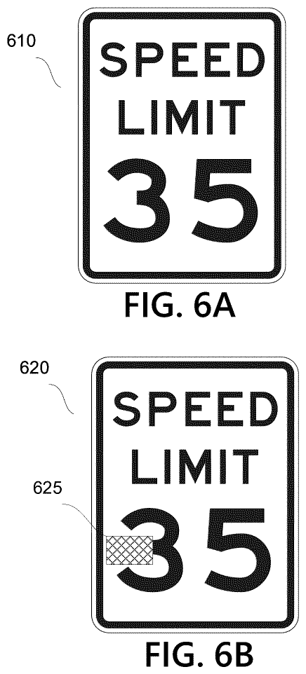

FIGS. 6A and 6B show an example of a ground truth example and an adversarial example modified based on that ground truth example. The example in FIGS. 6A and 6B may be consistent with the above-discussed example of which the traffic-sign image recognition model heavily relies on the graphical patterns around the junction area between the two half-circles of number “3” (or the junction area between the two circles of number “8”) to distinguish number “3” from number “8.” As shown in FIG. 6A, a ground truth example 610 may comprise an image of an ordinary 35-mile speed limit sign. The adversarial example generation model 235 may modify the ground truth example 610 and generate an adversarial example 620. As shown in FIG. 6B, a graphical pattern 625 may be added to the junction area between the two half-circles of the number “3.” The graphical pattern 625 may be generated and/or added to the ground truth example 610 by the adversarial example generation model 235. The graphical pattern 625 may simulate a colored tape or a piece of mud that is attached to the traffic sign.

It is appreciated that the adversarial example 620 is merely an example. An adversarial example may be generated by modifying the ground truth example in other ways, and/or by modifying other ground truth examples.

The adversarial example generation model 235 may be an ensemble, testing and applying a variety of strategies when generating the adversarial examples. For example, the adversarial example generation model 235 may use different algorithms to generate adversarial examples, and test which adversarial examples actually cause the first machine learning model 225 to generate the intended misclassification.

Referring back to FIG. 4, at step 420, the second computing device 230 may send, to the first machine learning model, the plurality of adversarial examples. The second computing device 230 may send the plurality of adversarial examples via the first computing device 220. The first machine learning model may be adjusted (e.g., retrained) based on the plurality of adversarial examples. For example, for each of the plurality of adversarial examples, the first machine learning model may generate an output, compare the actual output with a correct output (e.g., send from the second computing device 230), and/or adjust the parameters of the first machine learning model to produce the correct output. For example, the parameters of the first machine learning model (e.g., weights and biases as described in FIG. 3) may be adjusted, so that one or more heavily relied upon data points may be given less weight than before, and other data points may be given higher weights than before. Additionally or alternatively, the adversarial example generation model 235 may make the comparison and provide recommendations regarding how to adjust the parameters in the first machine learning model.

Consistent with the example in FIGS. 6A and 6B, the image recognition model may receive the modified traffic sign 620 as an adversarial example. The image recognition model, which initially overly relies on the junction area to distinguish between the number “3” and number “8,” may misclassify the adversarial example 620 as an 85-mile speed limit sign, instead of a 35-mile speed limit sign, even if an ordinary human being may have a very low chance to make the same misclassification. The image recognition model may receive data indicating a correct classification of the adversarial example 620 being a 35-mile speed limit, instead of an 85-mile speed limit. Based on the comparison, the parameters (e.g., weights and biases) of the image recognition model may be adjusted, so that the junction area is given less weight. For example, the adjusted first machine learning model may assign more weights on whether the two circles are full circles or half circles.

At step 425, the second computing device 230 may receive the output results (e.g., initial output results before the first machine learning model is retrained), from the first machine learning model, for each of the plurality of adversarial examples. The second computing device 230 may compare the output results from the first machine learning model with the corresponding correct outputs, for example, to determine whether each adversarial example successfully tricks the first machine learning model. Consistent with the example in FIGS. 6A and 6B, the second computing device 230 may receive, from the image recognition model, data indicating the image recognition model initially outputs a classification of the adversarial example 620 as an 85-mile speed limit sign.

At step 430, the second computing device 230 may retrain, based on whether the adversarial examples are misclassified by the first machine learning model or not, the adversarial example generation model 235. For example, if an adversarial example initially causes misclassification by the first machine learning model, which indicates that the adversarial example successfully tricks the first machine learning model, the misclassification from the first machine learning model may be treated as a reward in a reinforcement training of the adversarial example generation model 235. The adversarial example generation model 235 may generate adversarial examples using similar approaches in the future. If an adversarial example initially causes a correct classification by the first machine learning model, which indicates that the adversarial example does not successfully trick the first machine learning model, the correct classification from the first machine learning model may be treated as a penalty in the reinforcement training. The adversarial example generation model 235 may generate adversarial examples using different approaches in the future.

For example, consistent with the example described in FIGS. 6A and 6B, the adversarial example generation model 235 generates a second adversarial example by adding a small flower image next to the number “3.” The image recognition model may not be tricked by the added flower and output a correct classification. The parameters (e.g., weights and biases) of the adversarial example generation model 235 may be adjusted so that the future adversarial examples the adversarial example generation model 235 generates may be more similar to the adversarial example 620 with the junction area being taped, and/or less similar to the second adversarial example of which the flower is added.

Additionally or alternatively, the method may proceed back to step 415, for example, after the adversarial example generation model 235 is retrained. Improved adversarial examples may be generated to further train the first machine learning model 225 as described herein.

The steps of method 400 may be modified, omitted, or performed in other orders, or other steps added as appropriate.

FIG. 5 is a flow diagram depicting method 500 for generating adversarial examples in accordance with one or more illustrative aspects discussed herein. The steps in method 500 may be performed by a system comprising, for example, the first computing device 220, the second computing device 230, the adversarial example generation model 235, and/or the first machine learning model 225 as may be shown in FIG. 2. The method 500 may be implemented in connection with the method 400 depicted in FIG. 4.

At step 510, a first computing device 220 may send a request to generate the plurality of adversarial examples. The request may be sent to the second computing device 230 and may be the request described in step 405 of FIG. 4.

The request may be triggered based on certain conditions. For example, the request may be triggered based on the first machine learning model's accuracy rate (e.g., the percentage of output results that meet a satisfaction level) being lower than a threshold. The accuracy of the first machine learning model may be tested using a plurality of sets of testing data. Each set of testing data may comprise an input for the first machine learning model and data indicating an expected output from the first machine learning model. The actual output of the first machine learning model and the expected output may be compared. If the actual output matches the expected output, it may be determined that the actual output is accurate. If a high percentage of the actual outputs are not accurate, the request may be triggered.

Additionally or alternatively, the first machine learning model may indicate a respective confidence level associated with each output from the first machine learning model. The confidence level may indicate an estimation, by the first machine learning model, of how likely it is that the output is correct. A lower confidence level may indicate the first machine learning model is less certain of the output result, which may indicate a lower accuracy rate (even if the actual accuracy rate is not known). A request may be triggered if the confidence levels associated with a plurality of inputs satisfy a threshold (e.g., the average confidence level is lower than 80% for a certain period of time).

At step 515, the first computing device 220 may send the information associated with the first machine learning model. The information may be similar to the information described in step 410. The information may comprise a training goal as described in step 410. The information may facilitate the adversarial example generation model 235 to generate adversarial examples.

At step 520, the first computing device 220 may receive the plurality of adversarial examples. The plurality of adversarial examples may be generated by the adversarial example generation model 235 as described in step 415.

At step 525, the first computing device 220 may input the plurality of adversarial examples to the first machine learning model. The first computing device 220 may receive a plurality of outputs. Each of the plurality of outputs may correspond to a respective adversarial example of the plurality of adversarial examples. For example, consistent with FIGS. 6A and 6B, the adversarial example 620 may be input to the image recognition model. The image recognition model may output a classification of the adversarial example 620 as an 85-mile speed limit.

At step 535, the first computing device 220 may adjust (e.g., retrain) the first machine learning model. The retraining may be based on a comparison between a respective output for each of the plurality of adversarial examples and data indicating a correct classification for each of the plurality of adversarial examples. The retraining may be similar to the retraining as described in step 420.

Additionally or alternatively, the first computing device 220 may send feedback to the adversarial example generation model 235, so that the adversarial example generation model 235 may be retrained as described in step 430. The feedback may comprise the actual output results, made by the first machine learning model, for each input adversarial example. As described above in step 430, the second computing device 230 may retrain the adversarial example generation model 235 based on the feedback (e.g., based on each adversarial example successfully tricks the first machine learning model).

Additionally or alternatively, the second computing device 230 may receive a respective confidence level corresponding to each output result from the first machine learning model. The confidence level may be provided as feedback to indicate how successfully the adversarial example tricks the first machine learning model. For example, if a first adversarial example leads to an incorrect output accompanying a high confidence level, and a second adversarial example leads to an incorrect output accompanying a low confidence level, the first adversarial example may be determined as a more successful adversarial example than the second adversarial example. The adversarial example generation model 235 may be reinforced to produce further adversarial examples more similar to the first adversarial example.

The steps of method 500 may be modified, omitted, or performed in other orders, or other steps added as appropriate.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Accordingly, the scope of the invention should be determined not by the embodiments illustrated, but by the appended claims and their equivalents.

What is claimed is:

1. A method comprising:
receiving, by a computing device, a request to generate a plurality of adversarial examples for a first machine learning model, wherein the first machine learning model is configured to output a classification for an input, and wherein the plurality of adversarial examples are configured to be input to the first machine learning model and cause misclassification by the first machine learning model;
receiving information associated with the first machine learning model;
generating, based on the request and using a second machine learning model, the plurality of adversarial examples, wherein each of the plurality of adversarial examples is modified from a ground truth example; and
sending, to the first machine learning model, the plurality of adversarial examples, wherein the first machine learning model is configured to be adjusted based on a comparison between:
a respective output classification for each of the plurality of adversarial examples; and
data indicating a correct classification for each of the plurality of adversarial examples.

2. The method of claim 1, further comprising:
receiving, from the first machine learning model, the respective output classification for each of the plurality of adversarial examples; and
retraining, based on adversarial examples misclassified by the first machine learning model, the second machine learning model.

3. The method of claim 2, wherein the first machine learning model is further configured to output a respective confidence level associated with each output classification, and wherein the retraining the second machine learning model is further based on a respective confidence level corresponding to each of the output classification associated with the plurality of adversarial examples.

4. The method of claim 1, wherein the information associated with the first machine learning model comprises at least one of:
metadata associated with input fields of the first machine learning model; or
one or more parameters of the first machine learning model.

5. The method of claim 1, wherein the first machine learning model is configured to:
recognize an image; and
classify the recognized image into one of a plurality of categories.

6. The method of claim 1, wherein the generating the plurality of adversarial examples comprises:
determining one or more data points that are assigned, by the first machine learning model, a weight exceeding a threshold; and
modifying a portion, in each of a plurality of ground truth examples, that corresponds to the one or more data points.

7. The method of claim 1, further comprising:
receiving, from the first machine learning model, a plurality of confidence levels, each associated with a respective classification for a corresponding second input of a plurality of second inputs; and
triggering, based on the plurality of confidence levels satisfying a threshold, the request to generate the plurality of adversarial examples.

8. A system comprising:
a computing device; and
a first machine learning model;
wherein the computing device is configured to:
receive a request to generate a plurality of adversarial examples for the first machine learning model, wherein the plurality of adversarial examples are configured to be input to the first machine learning model and cause misclassification by the first machine learning model;
receive information associated with the first machine learning model;
generate, based on the request and using a second machine learning model, the plurality of adversarial examples, wherein each of the plurality of adversarial examples is modified from a ground truth example; and
send, to the first machine learning model, the plurality of adversarial examples;
wherein the first machine learning model is configured to:
receive the plurality of adversarial examples; and
output a classification for each of the plurality of adversarial examples; and
wherein the first machine learning model is configured to be adjusted based on a comparison between:
the classification for each of the plurality of adversarial examples; and
data indicating a correct classification for each of the plurality of adversarial examples.

9. A system of claim 8, wherein the computing device is further configured to:
receive, from the first machine learning model, the respective classification for each of the plurality of adversarial examples; and
retrain, based on adversarial examples misclassified by the first machine learning model, the second machine learning model.

10. The system of claim 9, wherein the first machine learning model is further configured to output a respective confidence level associated with each output classification, and wherein the retraining the second machine learning model is further based on a respective confidence level corresponding to each of the output classification associated with the plurality of adversarial examples.

11. The system of claim 8, wherein the information associated with the first machine learning model comprises at least one of:
metadata associated with input fields of the first machine learning model; or
one or more parameters of the first machine learning model.

12. The system of claim 8, wherein the first machine learning model is further configured to:
recognize an image; and
classify the recognized image into one of a plurality of categories.

13. The system of claim 8, wherein the computing device is configured to generate the plurality of adversarial examples by:
determining one or more data points that are assigned, by the first machine learning model, a weight exceeding a threshold; and
modifying a portion, in each of a plurality of ground truth examples, that corresponds to the one or more data points.

14. The system of claim 8, wherein the computing device is further configured to:
receive, from the first machine learning model, a plurality of confidence levels, each associated with a respective classification for a corresponding second input of a plurality of second inputs; and
trigger, based on the plurality of confidence levels satisfying a threshold, the request to generate the plurality of adversarial examples.

15. A non-transitory computer-readable medium storing computer instructions that, when executed by one or more processors, cause performance of actions comprising:
receiving a request to generate a plurality of adversarial examples for a first machine learning model, wherein the first machine learning model is configured to output a classification for an input, and wherein the plurality of adversarial examples are configured to be input to the first machine learning model and cause misclassification by the first machine learning model;
receiving information associated with the first machine learning model;
generating, based on the request and using a second machine learning model, the plurality of adversarial examples, wherein each of the plurality of adversarial examples is modified from a ground truth example; and
sending, to the first machine learning model, the plurality of adversarial examples, wherein the first machine learning model is configured to be adjusted based on a comparison between:
a respective output classification for each of the plurality of adversarial examples; and
data indicating a correct classification for each of the plurality of adversarial examples.

16. The non-transitory computer-readable medium storing computer instructions of claim 15, when executed by the one or more processors, further cause performance of actions comprising:
receiving, from the first machine learning model, the respective output classification for each of the plurality of adversarial examples; and
retraining, based on adversarial examples misclassified by the first machine learning model, the second machine learning model.

17. The non-transitory computer-readable medium storing computer instructions of claim 16, wherein:
the first machine learning model is further configured to output a respective confidence level associated with each output classification; and
the instructions, when executed by the one or more processors, cause retaining the second machine learning model further based on a respective confidence level corresponding to each of the output classifications associated with the plurality of adversarial examples.

18. The non-transitory computer-readable medium storing computer instructions of claim 15, wherein the information associated with the first machine learning model comprises at least one of:
metadata associated with input fields of the first machine learning model; or
one or more parameters of the first machine learning model.

19. The non-transitory computer-readable medium storing computer instructions of claim 15, wherein the instructions, when executed by the one or more processors, cause generating the plurality of adversarial examples by:
determining one or more data points that are assigned, by the first machine learning model, a weight exceeding a threshold; and
modifying a portion, in each of a plurality of ground truth examples, that corresponds to the one or more data points.

20. The non-transitory computer-readable medium storing computer instructions of claim 15, wherein the instructions, when executed by the one or more processors, further cause performance of actions comprising:
receiving, from the first machine learning model, a plurality of confidence levels, each associated with a respective classification for a corresponding second input of a plurality of second inputs; and
triggering, based on the plurality of confidence levels satisfying a threshold, the request to generate the plurality of adversarial examples.
